(19) United States
(12) Patent Application Publication
(10) Pub. No.: US 2013/0147631 A1
(43) Pub. Date: Jun. 13, 2013

(54) SERVER SYSTEM AND FAN INDICATION METHOD

(71) Applicants: KANG WU, Shenzhen (CN); WEI-DONG CONG, Shenzhen (CN)

(72) Inventors: KANG WU, Shenzhen (CN); WEI-DONG CONG, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/340,634

(22) Filed: Dec. 29, 2011

(30) Foreign Application Priority Data
Dec. 8, 2011 (CN) 201110405752.2

(51) Int. Cl. G09F 9/33

(52) U.S. Cl. 340/815.45

(57) ABSTRACT

A server system includes a number of fan control units, a number of fan rows, a determination module, a control module, and a digital display unit. One fan control unit corresponds to one fan row. Each fan control unit reads a rotating speed of each fan mounted on a corresponding fan row, and encodes the read rotating speed positional information of the corresponding fan row and positional information of the fan on the corresponding fan row. The determination module determines whether the read rotating speed is within a predetermined rotating speed range. If the rotating speed is out of the predetermined rotating speed range, the determination module outputs the code of the one rotating speed to the control module. The control module controls a digital display unit to numerically display the code of the rotating speed.

### BACKGROUND

1. Technical Field

The present disclosure relates to a server system and a fan indication method.

2. Description of Related Art

In rack servers, a plurality of fans are mounted in rows on a back of an enclosure of the rack servers to dissipate heat from the servers. Some indicator lights are mounted on the fan housings to indicate the status of the fans. However, because these indicator lights are at the back of the enclosure, it is inconvenient for users to observe the indicator lights and determine the status of the fans.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present disclosure. Moreover, in the drawings, all the views are schematic, and like reference numerals designate corresponding parts throughout the several views.

FIG. 1 is a schematic view of an exemplary embodiment of a server system, wherein the server system includes a fan indicator system.

FIG. 2 is a block diagram of an exemplary embodiment of the fan indicator system of FIG. 1.

FIG. 3 is a flowchart of an exemplary embodiment of a fan indication method.

### DETAILED DESCRIPTION

The disclosure, including the accompanying drawing in which like references indicate similar elements, is illustrated by way of example and not by way of limitation. References to “an” or “one” embodiment in this disclosure are not necessarily to the same embodiment, and such references mean at least one.

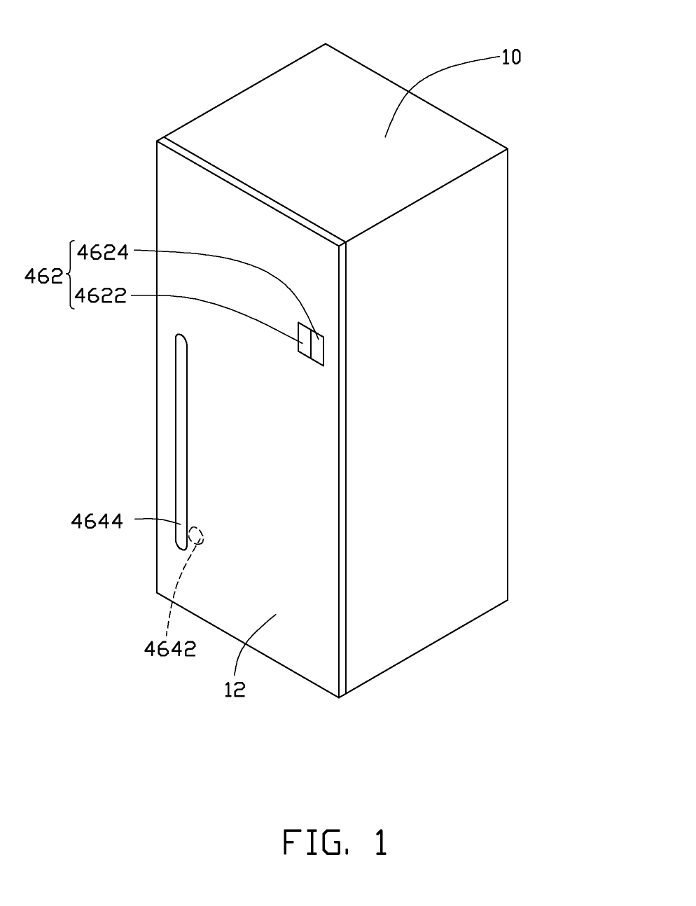

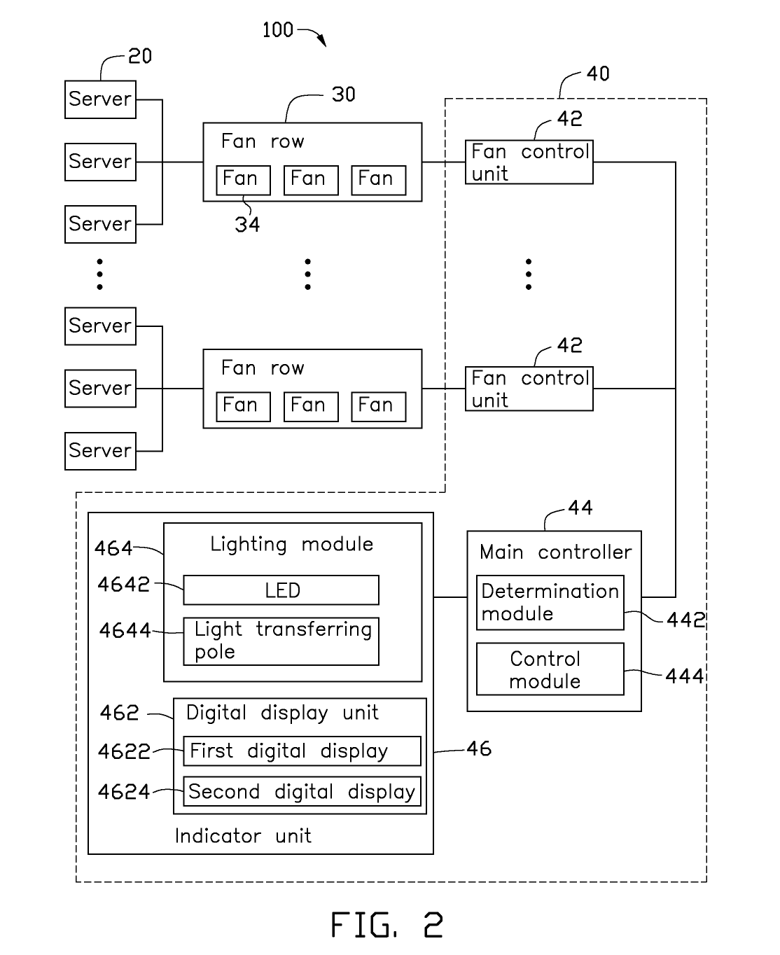

Referring to the FIGS. 1 and 2, an embodiment of a server system 100 includes an enclosure 10, a plurality of groups of servers 20 received in the enclosure 10, a plurality of fan rows 30, and a fan indicator system 40. Each fan row 30 includes a plurality of fans 34. One fan row 30 serves one group of servers 20 to dissipate heat from the group of servers 20.

The fan indicator system 40 includes a plurality of fan control units 42, a main controller 44, and an indicator unit 46. Each fan control unit 42 corresponds to one fan row 30. The fan control unit 42 can read a rotating speed of each fan 34 in the fan row 30. Each fan control unit 42 stores positional information regarding the fan row 30 which it controls and positional information regarding each fan 34 in the fan row 30.

The fan control unit 42 encodes the read rotating speeds according to the stored positional information of the corresponding fan row 30 and the positional information of each fan 34 on the corresponding fan row 30. Each code consists of a first value and a second value. The first value gives the positional information of the fan row 30 which the read rotating speed comes from. The second value denotes the positional information of the fan which the read rotating speed comes from on the corresponding fan row 30. The fan control unit 42 is connected to the main controller 44 and outputs the rotating speeds together with the codes to the main controller 44. The main controller 44 is connected to the indicator unit 46.

The main controller 44 includes a determination module 442 and a control module 444.

The determination module 442 receives the rotating speeds with the codes, and determines whether the rotating speeds are within a predetermined rotating speed range. If the rotating speeds are within the predetermined rotating speed range, it denotes that the fan 34 is normal. If one of the rotating speeds is out of the predetermined rotating speed range, the fan 34 rotating at that speed is working abnormally. The determination module 442 outputs the code corresponding to the rotating speed of the abnormal fan 34 to the control module 444.

The control module 444 turns on the indicator unit 46 after receiving the code corresponding to the rotating speed of the abnormal fan 34.

The indicator unit 46 includes one or more 7-segment LED digital numerical displays or similar device (digital display unit 462) and a lighting module 464. The digital display unit 462 and the lighting module 464 are mounted on a front panel 12 of the enclosure 10. The digital display unit 462 includes a first display 4622 and a second display 4624. The first display 4622 displays the first value of the received code to denote that the positional information of the fan row 30 on which the abnormal fan 34 is mounted. The second display 4624 displays the second value of the received code to denote the positional information of the abnormal fan 34 on the fan row 30 corresponding to the displayed first value of the received code. The lighting module 464 includes a light emitting diode (LED) 4642 and a light transferring pole 4644. The LED 4642 is mounted on a lower portion of the light transferring pole 4644. When the LED 4642 is lit, the light transferring pole 4644 is illuminated so as to present a signal visible from outside the enclosure 10.

In the embodiment, if the control module 444 receives many codes, the control module 444 controls the digital display unit 462 to display the received codes one by one, and turns on the LED 4642 to illuminate the light transferring pole 4644.

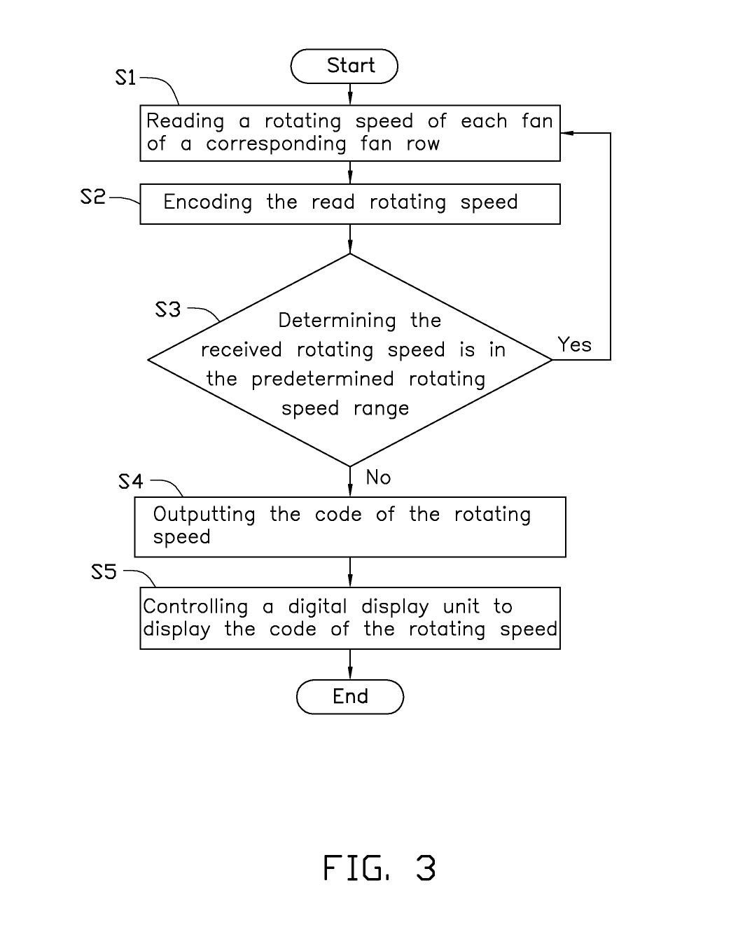

Referring to FIG. 3, an exemplary embodiment of a fan indication method includes the following steps.

In step S1, each fan control unit 42 reads the rotating speed of each fan 34 of the corresponding fan row 30.

In step S2, each fan control unit 42 encodes the read rotating speed of the fan 34 according to the stored positional information of the corresponding fan row 30 and the positional information of each fan 34 on the corresponding fan row 30, and outputs the rotating speed with the code.

In step S3, the determination module 442 determines whether the received rotating speed with the code is within the predetermined rotating speed range. If the received rotating speed with the code is within the predetermined rotating speed range, the procedure goes back to step S1. If the rotating speed with the code is out of the predetermined rotating speed range, the procedure goes to step S4.

In step S4, the determination module 442 outputs the code of the rotating speed to the control module 444.

In step S5, the control module 444 controls the digital display unit 462 to display the code of the rotating speed. Specifically, the control module 444 controls the first display 4622 to display the first value of the received code to denote the positional information of the fan row 30 on which the abnormal fan 34 is mounted, and controls the second display 4624 to display the second value of the received code denote the positional information of the abnormal fan 34 on the fan row 30, and illuminates the LED 4642.

Although numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A server system comprising:
an enclosure comprising a front panel;
a plurality of groups of servers received in the enclosure;
a plurality of fan rows each corresponding to one group of servers, and comprising a plurality of fans to dissipate heat from the corresponding group of servers; and
a fan indicator system comprising:
a plurality of fan control units, wherein one fan control unit is connected to one of the fan rows to read the rotating speeds of the fans of the corresponding fan row, each fan control unit stores positional information of the corresponding fan row and positional information of each fan on the corresponding fan row, each fan control unit encodes the read rotating speed according to the positional information of the corresponding fan row and the positional information of each fan on the corresponding fan row, and outputs the rotating speed with a code;
a digital display unit mounted on the front panel of the enclosure; and
a main controller comprising:
a determination module to receive the rotating speed with the code, and determine whether the received rotating speed is within a predetermined rotating speed range, wherein if the received rotating speed is out of the predetermined rotating speed range, the determination module outputs the code of the rotating speed; and
a control module to receive the code of the rotating speed to control the digital display unit to display the received code to denote that the fan corresponding to the displayed code is abnormal.

2. The server system of claim 1, wherein the fan indicator system further comprises a lighting module mounted on the front panel of the enclosure, the control module turns on the lighting module after receiving the code of the rotating speed of the abnormal fan.

3. The server system of claim 2, wherein the lighting module comprises a light emitting diode (LED) and a light transferring pole, the LED is mounted on a lower portion of the light transferring pole, when the control module receives the code of the rotating speed of the abnormal fan, the control module turns on the LED, and the light transferring pole is illuminated.

4. The server system of claim 1, wherein the digital display unit comprises a first digital display and a second digital display, the code consists of a first value and a second value, the first digital display displays the first value of the received code to denote the positional information of the fan row on which the abnormal fan is mounted, the second digital display displays the second value of the received code to denote the positional information of the abnormal fan on the fan row corresponding to the displayed first value of the received code.

5. A fan indication method for displaying performance of fans mounted on a plurality of fan rows of a server system, the method comprising:
reading a rotating speed of each fan of each of the plurality of fan rows;
encoding the read rotating speed according to stored positional information of the fan row and positional information of each fan on the fan row, and outputting the rotating speed with a code;
determining whether the received rotating speed with the code is within a predetermined rotating speed range; if the received rotating speed with the code is within the predetermined rotating speed range, the procedure goes back to the step of reading the rotating speed;
outputting the code of the rotating speed if the rotating speed with the code is out of the predetermined rotating speed range; and
controlling a digital display unit to display the received code of the rotating speed.

6. The fan indication method of claim 5, after the step of controlling, further comprising:
initiating a lighting module mounted on a front panel of an enclosure of the server system after receiving the code of the rotating speed.

7. The fan indication method of claim 6, wherein the light module comprises a light emitting diode (LED) and a light transferring pole, the LED is mounted on a lower portion of the light transferring pole, wherein in the step of turning on, the LED is turned on after receiving the code of the rotating speed to illuminate the light transferring pole.

8. The fan indication method of claim 6, wherein if the rotating speed is out of the predetermined rotating speed range, it denotes that the fan corresponding to the rotating speed is abnormal, the digital display unit is one or more 7-segment LED digital numerical displays, the digital display unit comprises a first digital display and a second digital display, the code consists of a first unit and a second value, in the step of controlling, the first digital display is controlled to display the first value of the received code to denote the positional information of the fan row on which the abnormal fan is mounted, the second digital display is controlled to display the second value of the received code to denote the positional information of the abnormal fan on the fan row corresponding to the displayed first value of the received code.
